(19) United States
(12) Patent Application Publication
(10) Pub. No.: US 2006/0057036 A1
(43) Pub. Date: Mar. 16, 2006

(54) System for elimnating polluting gases produced from combustion processes

(76) Inventor: Angel Ayala Hermosillo, Estado de Mexico (MX)

Correspondence Address: David A Harlow;Nelson Mullins Riley & Scarborough, 1320 Main Street, P O Box 11070, Columbia, SC, 29201, US

(21) Appl. No.: 10/532,177

(22) PCT Filed: Sep. 10, 2003
(86) PCT No.: PCT/MX03/00071

§ 371 Date: Apr. 21, 2005

(51) Int. Cl. B01D 53/34

(52) U.S. Cl. 422/171; 422/173; 422/168; 422/225

(57) ABSTRACT

This invention relates to systems for eliminating completely from the atmosphere the polluting gases produced from a combustion system. The system of the present invention comprises a series of vessels wherein the pollutant gases are mixed with water and reacted with inorganic materials such group II metal hydroxides to remove carbon dioxide as carbonates and bicarbonates. Non reacted gases are recycled back into the combustion system. The present invention is particularly adaptable to internal combustion engines.

### FIELD OF THE INVENTION

The present invention is related to systems for eliminating the environmental pollution that is generated from the exit gases issued from combustion processes that use hydrocarbons, such as, for example, gasoline, natural gas, methane, diesel, and other fuels such as, for example, mineral carbon and vegetal carbon.

### BACKGROUND OF THE INVENTION

In the present day, there is a great concern for eliminating the environmental pollution produced by combustion processes that occur in the industry and, to a great extent, in urban areas, due to the use of automobiles. This environmental pollution presents problems in many places on the world, for example in Mexico City, because it has a negative impact in many respects, among which the thermal inversion effect, global warming, abrupt temperature changes that cause effects such as the one known as “El Nino”, destruction of the ozone layer in the atmosphere, acid rain, and others can be named. These problems, further from menacing the planet's equilibrium, have harmful effects on the health of human beings.

The majority of fuels used for combustion form residual gases comprised primarily of carbon monoxide, carbon dioxide, nitrogen oxides, sulfur oxides, and non-combusted hydrocarbons. Under favorable conditions, analysis of the residual gases shows that a high percentage is carbon dioxide. When combustion is more efficient, an even higher percentage of carbon dioxide is generated based on the total residual gases produced. On the other hand, when combustion is not as efficient, less carbon dioxide and higher percentages of the other residual gases are produced.

In the case of automotive motors, some of the systems currently used to enhance the combustion are the fuel injection systems, which use a plurality of sensors that send information to a controller which determines the necessary air and fuel mixture to enhance combustion.

For automobiles, catalytic converters are widely used. Catalytic converters have the function of reducing the emission into the atmosphere of polluting gases such as carbon monoxide, non-combusted hydrocarbons and nitrogen oxides. However, these devices are expensive, because they use expensive materials such as platinum, palladium, rhodium, and others precious metals. Further, their efficiency is gradually reduced with time and does not resolve the acid rain problem cause by the emission of the sulfur oxides.

Another improvement in automotive motors is the use of platinum and multi-electrode sparking plugs, which are more durable and require less maintenance. This improvement helps to protect the automobile's catalytic converter, so that it has a higher useful lifetime.

However, none of these solutions has been able to eliminate the emissions of pollutant residual gases such as carbon dioxide, carbon monoxide, nitrogen oxides, non-combusted hydrocarbons, and sulfur oxides. So there is a need to find an alternative to eliminate emissions of pollutant gases produced by automobiles and industry from the combustion of hydrocarbons and other fuels, because these emissions to the atmosphere are harmful for the planet and living beings.

### SUMMARY OF THE INVENTION

The present invention comprises, in a preferred embodiment, a system for eliminating pollutant gases produced by a combustion system. The system of the present invention comprises a first vessel containing water receives a pollutant gases stream emitted by a combustion system through a first tube. Water of the first vessel is used to dissolve a fraction of the carbon dioxide that is part of the pollutant gases stream. A mixture of gases and water exits the first vessel and is directed to a third vessel through a second tube. A connection between the second tube and a second vessel containing inorganic material is through a third tube, so that the gases and water mixture stream sucks the inorganic material through to the second tube, and the inorganic material reacts with carbon dioxide contained in the gases and water mixture stream to form carbonates. Carbonates are deposited into the third vessel, which serves as a mixing chamber so that reactions between the inorganic material and carbon dioxide occur to form the carbonates. Subsequently, non-reacted gasses are directed through a fourth tube to a fourth vessel, which contains water, where the non-reacted carbon dioxide is dissolved in water and the gas stream is cooled, which upon exiting the fourth vessel is directed back to the combustion system, from which they originally came, through a fifth tube, so that this process becomes continuous because vacuum formed in the combustion system pulls the gas current which in turn pushes while more gases are generated in the combustion system.

An alternative embodiment of the present invention comprises an system, which injects water into a pollutant gases stream issued by a hydrocarbon combustion system in a first tube. The injected water is mixed with the pollutant gases mixture. The gases and water mixture is directed to a second vessel through the first tube. A connection between the first tube and a first vessel containing inorganic material is through a second tube so that the gases and water mixture stream sucks the inorganic material through the second tube wherein the inorganic material reacts with carbon dioxide contained in the gases and water mixture stream to form carbonates. The carbonates are deposited in the second vessel, which serves as a mixing chamber where reactions between the inorganic material and carbon dioxide occur to form the carbonates. Subsequently, non-reacted gasses are directed through a third tube to a third vessel, which contains water, where the non-reacted carbon dioxide is dissolved in water and the gas stream is cooled, which upon exiting the third vessel is directed back to the combustion system from which they originally came through a fourth tube, Thus, this process becomes continuous because the vacuum formed in the combustion system pulls the gas current, which in turn, pushes while more gases are generated in the combustion system.

Therefore, it is an objective of the present invention to provide a system that eliminates the all of the pollution produced from gas emissions to the atmosphere coming from a combustion process.

It is another objective of the present invention to provide an alternative for automobile vehicle pollution control that is more efficient and less costly than the existing systems, such as, for example, catalytic converters, microcomputers, air and fuel injection controllers, and others.

A further objective of the present invention is to provide a system for eliminating pollutant gases produced in combustion processes used in the industry, such as, for example, electricity generation, steam generation in boilers, and other energy generation processes that use hydrocarbon and other fuels, such as, for example, carbon, combustion.

### BRIEF DESCRIPTION OF THE DRAWINGS

FIG. 1 shows a schematic diagram of the preferred embodiment of the system for eliminating gases of the present invention.

FIG. 2 shows a schematic diagram of an alternative embodiment of the system for eliminating gases of the present invention.

### DETAILED DESCRIPTION OF THE INVENTION

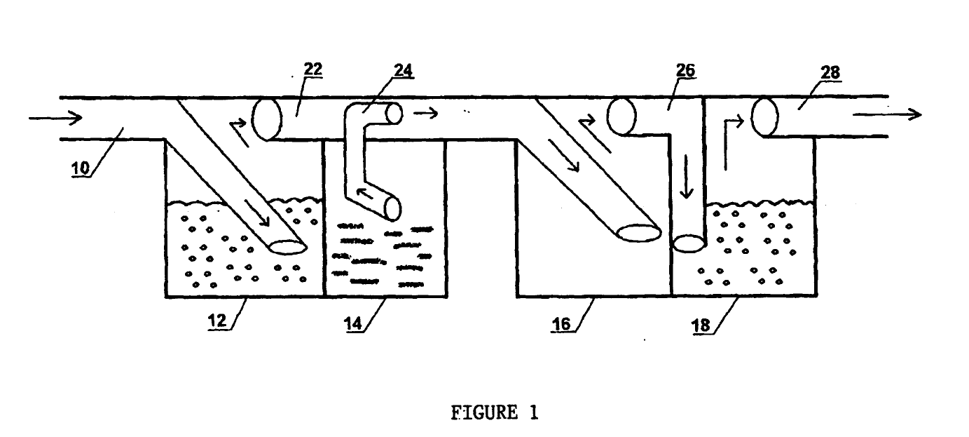

The preferred embodiment of the system for eliminating gases of the present invention to eliminate all the gases coming from a combustion system, for example, an internal combustion motor of an automobile vehicle with an intake and an emission area, has four vessels, as can be seen from FIG. 1, each with different functions. The first vessel 12 of FIG. 1 contains water. The first vessel 12, i.e., a mixing vessel, receives the combustion exit gases coming from a first tube 10 connected to a combustion system (not shown in FIG. 1). The combustion emission gases that enter the first vessel 12 are mixed with the water in the first vessel 12 before leaving the first vessel 12.

The water and gases mixture coming from the first vessel 12 exits the first vessel 12 through a second tube 22 and goes to a third vessel 16, i.e., a reaction vessel, as can be seen in FIG. 1. The second tube 22, which leads the water and gases mixture, is joined to a third tube 24 coming from a second vessel 14. The second vessel 14, i.e. the supply vessel, contains inorganic material that can be sucked by the pressure of the water and gases mixture and will be sent with the water and gases mixture to the third vessel 16.

The water and gases mixture coming from the first vessel 12 and the inorganic material sucked from the second vessel 14 arrive in the third vessel 16, which serves as a mixing chamber. The mixing chamber 16 initially is empty. However, in the mixing chamber 16 solid products will be deposited, the solid products are the result of a reaction process that will be discussed in detail herein below.

The gas mixture that exits the third vessel 16 enters the fourth vessel 18 through a fourth tube 26, which also contains water. The mixture of gases also mixes with the water in the fourth vessel 18, i.e. a second mixing vessel, and exits the system through a passage such as a fifth tube 28 to return to the intake of the combustion system(not shown in FIG. 1). Therefore, a recycling is created with the combustion system making the system of the present invention a continuous process. This is possible in automobile vehicles by a double effect of pushing and pulling. The vacuum created by the motor suck in air and fuel to be burned in the combustion chamber pulls the air stream, while the same stream is pushing the gases simultaneously.

The combustion emission gases are non burned hydrocarbons, carbon monoxide, nitrogen oxides, sulfur oxides and, primarily, carbon dioxide. Upon an analysis of the gases, it can be observed that whenever there is an efficient combustion, the percentages of the gases are expressed with an increase in the carbon dioxide percentage, as well as decrease to very small quantities of the other gases. In the combustion systems, if the combustion is complete, 100% of the combustion reaction product would be CO₂. However, in reality, this does not occur.

Since most of the residual gases effluent from combustion is carbon dioxide, and due to the gas characteristic of not supporting combustion, as is known to those skilled in the art, since the gas is used in commerce to extinguish fires, it is necessary to separate the carbon dioxide from other residual gases for the other gases to be allowed to recirculate to the combustion system for their complete treatment.

The CO₂ treatment inside the system of the present invention is done first by passing the exit gases stream coming from the combustion system through the first vessel 12, which as previously discussed, contains water. As CO₂ is soluble in water (with a solubility of approximately 2 g/L), part of the CO₂ in the stream is dissolved in water contained in the first vessel 12. Moreover, due to the fact that the residual gases stream is under pressure, it also exits the first vessel 12 carrying part of the water contained inside the first vessel 12. Upon exiting the first vessel 12, the gases and water mixture stream is sent to the third vessel 16. In it path to the third vessel 16, the gases and water mixture stream sucks inorganic material contained in the second vessel 14 through a third tube 24 that connects the second tube 22 which transports the gases and water mixture stream with the second vessel 14 that contains the inorganic material. The inorganic material contained inside the second vessel 14 is selected from a group that consists of oxides and hydroxides from metals of Groups IA and IIA of the Periodic Table of the Elements. In a more preferred embodiment, the inorganic material is selected from a group that consists of sodium hydroxide, potassium hydroxide, calcium hydroxide, lithium hydroxide, rubidium hydroxide, cesium hydroxide, francium hydroxide, beryllium hydroxide, magnesium hydroxide, strontium hydroxide, barium hydroxide, radium hydroxide, their oxide forms, and mixtures thereof. In a more preferred embodiment of the invention, the inorganic material is selected from a group that consists of sodium hydroxide, potassium hydroxide, calcium hydroxide, and mixtures thereof. Therefore, when the gases and water mixture stream and the inorganic material arrive to the third vessel 16, which serves as a mixing chamber, in the preferred embodiment, one or more of the following chemical reactions between CO₂ and inorganic material can occur:
M¹OH+CO₂→M¹₂CO₃+H₂O
M²(OH)₂+CO₂→M²CO₃+H₂O
M¹₂O+CO₂→M¹₂CO₃
M²O+CO₂→M²CO₃

wherein M¹ is a group IA metal, M² is a group IIA metal. As it can be observed from the above reactions, the inorganic material in its hydroxide forms reacts with carbon dioxide to form carbonates and water, while the inorganic material in its oxide forms reacts with carbon dioxide to form carbonates. The carbonates formed from the above reactions are deposited in the mixing chamber. Further, the carbonates formed from the above reactions can keep reacting with carbon dioxide to form bicarbonates, therefore consuming more carbon dioxide from the pollutant gases. The following reactions exemplify the conversion process from carbonates to bicarbonates:
M¹₂CO₃+H₂O+CO₂→2M¹HCO₃
M²CO₃+H₂O+CO₂→M²(HCO₃)₂

wherein M¹ is a group IA metal, M² is a group IIA metal.

On the other hand, the rest of the gases follow the path marked by arrows in FIG. 1 to the fourth vessel 18, which, as the first vessel 12, also contains water. The function of this fourth vessel 18 is to dissolve CO₂ not reacted with inorganic material to form carbonates, as well as helping to cool the other gases so that they don't overheat the combustion system when they exit the fourth vessel 18 through a passage, such as a fifth tube 28, for reentering the combustion system.

Other than carbon dioxide, the other gases that come from a combustion system, are mainly are carbon monoxide, nitrogen oxides, non-combusted hydrocarbons, and sulfur dioxide. With respect to carbon monoxide, this gas is produced when combustion is incomplete, which happens in most of the combustion systems. When passing the gases stream through the combustion system of the present invention, carbon monoxide (CO) remains intact during the process, since it is not soluble in water of either first vessel 12 or fourth vessel 18, and it doesn't react with the inorganic material of the second vessel 14. The objective regarding the carbon monoxide in the present invention's system is to be able to recycle it back to the combustion system where it was generated, with that allowing it to complete its combustion in the combustion system passing from carbon monoxide to carbon dioxide. Therefore, when combustion is completed for the carbon monoxide to carbon dioxide, carbon dioxide generated enters the system for eliminating pollutant gases of the present invention, to give it the above mentioned treatment. It must be pointed out that carbon monoxide (CO) has the quality to be also used as fuel since, as it is known to those skilled in the art, carbon monoxide is an important component of low calorific power fuels, such as “water gas” and “generator gas”. The gases have been used as heating gases and for energy production. Water gas, with formula CO+H₂, has a calorific energy of approximately 3,000 Kcal/m³, and generator gas, with formula 4N₂+2CO, has a calorific energy approximately of 1,000 Kcal/m³. As a result of the above mentioned recycling of the carbon monoxide, upon reentering to the combustion process and mixing with air and fuel, the carbon monoxide would complete its combustion converting to carbon dioxide, so avoiding its emission to the environment.

With respect to nitrogen oxides (NOₓ), the compounds are formed in combustion processes due to nitrogen existing in air from the atmosphere, which under conditions existing in combustion processes strongly tends to combine with oxygen. As with carbon monoxide, the objective is its transport through the system to reentrance to the combustion system in which it generated. The objective of reentering the nitrogen oxides (NOₓ) into the combustion process is to used then properly as fuel since, as is know to those skilled in the art, nitrogen oxides (NOₓ) are used as fuels primarily in the automobile racing industry. This is because the nitrogen oxides are used as oxygen sources and allow very fast increases in the vehicle's acceleration. Therefore, the reentrance of nitrogen oxides (NOₓ) to the combustion system of an automobile vehicle's motor provides an additional advantage to the pollution elimination system of the present invention. It must be mentioned that a fraction of the nitrogen oxides can react with inorganic material, particularly when the inorganic material is in its hydroxide form, forming nitrates and nitrites.

Similarly, it occurs with non-combusted hydrocarbons that enter the pollution elimination system simple to be transported back to the combustion process from which they come, with the objective to be used in such combustion process as fuel. The utility of recycling non-combusted hydrocarbons for its use as fuel in the combustion process, further from avoiding its emission to the atmosphere where the non-combusted hydrocarbons would convert into environment pollutants, constitutes an additional advantage of the pollutant elimination system of the present invention.

As hydrocarbons used as fuels generally come from petroleum, it is common to find sulfur oxides (SOₓ) in the pollutant gases of the combustion systems. Moreover, when carbon is used as fuel, sometimes it also contains sulfur impurities that generate the sulfur oxides. These gases are also eliminated with the pollutant elimination system of the present invention. Similarly, as with carbon dioxide, sulfur dioxide, SO2, reacts with inorganic material from the second vessel 14 to form sulfites and sulfates, respectively. As an example, the reactions that may occur between the sulfur dioxide and the inorganic material when it is in form of group IA and IIA metal hydroxides are the following:
2M¹OH+SO₂→M¹₂SO₃+H₂O
M²(OH)₂+SO₂→M²SO₃+H₂O

wherein M¹is a group IA metal, M² is a group IIA metal. It must be pointed out that a very small fraction of the sulfur dioxide in the pollutant gases stream forms sulphurous acid when contacted with water, as can be explained from the formula:
SO₂+H₂O→H₂SO₃
the reaction being the one that occurs in the environment when the gas is mixed with rain water to form the so called acid rain, therefore the importance of those compounds not being liberated to the environment, as is achieved by the present invention. In this case some important considerations must be taken into account. One of them is that the material which forms the vessels must be resistant to the acid solution formed when sulfur dioxide contained in the pollutant gases stream is dissolved in water when passing the stream through the first vessel. Therefore it is preferred that the vessels used in the present invention, particularly the first vessel, are manufactured from a material which resists the acidity produced by mixing the sulfur oxides and water. Such materials preferably are selected from the group which consists of polypropylene, metals, polycarbonates, and nylon, with polypropylene being most preferred due to cost matters.

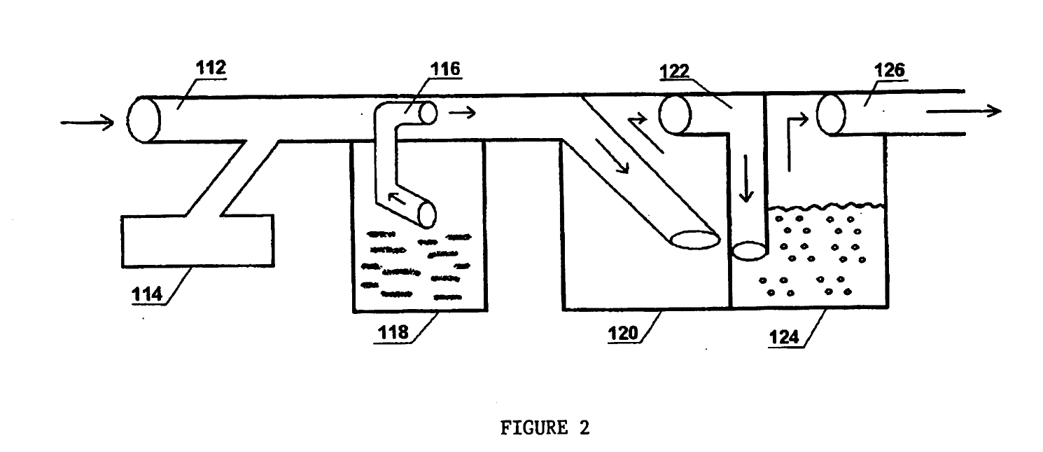

In an alternative embodiment of the present invention, as can be better observed in FIG. 2, the emission of gases from the combustion process enter the pollutant elimination system of the present invention by a first tube 112, in which they are mixed with water injected by a water injection system 114. The gases and water mixture is directed to a second vessel 120 by the first tube 112. A connection is made by a second tube 116 in between the first tube 112 and a first vessel 118, which first vessel 118 contains inorganic material, so that the gases and water mixture stream sucks the inorganic material, which in turn will react with carbon dioxide contained in the gases and water mixture stream to form carbonates. Carbonates are deposited in the second vessel 120, which serves as a mixing chamber for the reactions between inorganic material and carbon dioxide take place to produce the carbonates. Afterwards, the non-reacted gases are taken by a third tube 122 to a third vessel 124, which contains water, where non-reacted carbon dioxide is dissolved in water and further it cools the gas stream that upon exiting the third vessel it goes back to the combustion system from where it originally came from by a fourth tube 126, so that it converts into a continuous process, due to the vacuum formed in the combustion system pulling the gas stream, which in turn pushes as more gases are generated in the same combustion system. The advantage of this embodiment, providing at the start of the system of the present invention a water injection system 114, is that a better moisture is achieved, which is required to improve and accelerate the carbon dioxide and inorganic material reaction, also avoiding back pressure generation in the system with which the system becomes more fluid.

In a preferred embodiment, part of the water in the third vessel 124 of the pollutant elimination system of the present invention is recycled to be used in the water injection system.

Although the system for eliminating polluting gases has been described herein with reference primarily to an application for an internal combustion motor of an automobile, it is possible, as will be obvious to one skilled in the art, to adapt the system for eliminating polluting gases to industrial processes, such as, for example, hydrocarbon and/or carbon combustion for electric energy generation, for steam generation in boilers, and other processes for energy generation from hydrocarbon and/or carbon combustion.

In an alternative embodiment of the present invention, an air admission pump is located at the system entrance to enhance the mixture of polluting gases with water and inorganic material.

The preferred embodiments previously mentioned have describe the present invention incorporating tubes. However, this has been described in such manner for convenience, which doesn't imply that there are other embodiments, as will be obvious for one skilled in the art, that include other types of ducts, lines, and the like instead of the previously mentioned tubes.

The present invention has been described with base in the preferred embodiments, such does not imply, however, that there are not other embodiments derived from the scope of the invention. In particular, it is evident that it is possible to include in the invention, as it has been described and illustrated, several changes and modifications that can be done by one skilled in the art to which the present is referred, and that such changes and modifications are comprised in the present invention and in particular within the scope defined according to the appended claims.

I claim:

1. A system for eliminating emissions to the atmosphere of pollutant gases comprising carbon dioxide and other gases produced by a combustion process in a combustion system having an intake and an emission area, comprising:
a first mixing system wherein the pollutant gases being emitted from the emission area of the combustion system are mixed with water, dissolving part of the pollutant gases in water and forming a polluting gases and water mixture stream;
a reaction system in communication with the first mixing system wherein the carbon dioxide in the pollutant gases and water mixture stream coming from the first mixing system reacts with inorganic material at elevated temperatures to form carbonates, bicarbonates and water, the carbonates, bicarbonates and water being deposited in a chamber;
a second mixing system containing water in communication with the reaction vessel wherein the pollutant gases not reacted with the inorganic material in the reaction vessel are mixed with water, dissolving part of the polluting gases in the water;
a return passage wherein the pollutant gases not dissolved are returned from the second mixing system to the intake area of the combustion system.

2. The system of claim 1, wherein the reaction system comprises a vessel with inorganic material and where the chamber is a mixing chamber, where inorganic material is sucked by the gases stream through a duct that connects the inorganic material vessel to the duct that carries the polluting gases and water mixture stream, and the reaction between the inorganic material and polluting gases occurs in the mixing chamber, in which the carbonates produced are deposited.

3. The system of claim 2, wherein the polluting gases produced by the combustion system are formed primarily of carbon dioxide, carbon monoxide, nitrogen oxides, sulfur oxides, and non-combusted hydrocarbons.

4. The system of claim 3, wherein carbon monoxide is recycled to the combustion system so that upon burning with an air and fuel mixture its combustion is completed, forming primarily carbon dioxide.

5. The system of claim 4, wherein part of the nitrogen oxides react with inorganic material to form nitrates and nitrites, which nitrates and nitrites are deposited in the mixing chamber.

6. The system of claim 5, wherein the nitrogen oxides that do not react with inorganic material are recycled to the combustion system to be used as oxygen sources to enhance combustion in the combustion system.

7. The system of claim 6, wherein part of the sulfur dioxide reacts with inorganic material to form sulfites and water, the sulfites being deposited in the mixing chamber.

8. The system of claim 7, wherein part of the sulfur dioxide that does not react with inorganic material reacts with water to form primarily sulphurous acid.

9. The system of claim 8, wherein the inorganic material contained in the inorganic material vessel is selected from the group that consists of oxides and hydroxides of Periodic Table of Elements groups IA and IIA metals.

10. The system of claim 9, wherein the inorganic material contained in the inorganic material vessel is selected from the group that consists of sodium hydroxide, potassium hydroxide, calcium hydroxide, lithium hydroxide, rubidium hydroxide, cesium hydroxide, francium hydroxide, beryllium hydroxide, magnesium hydroxide, strontium hydroxide, barium hydroxide, radium hydroxide, oxides thereof, and mixtures thereof.

11. The system of claim 10, wherein the hydroxides contained in the inorganic material vessel are selected from the group that consists of sodium hydroxide, potassium hydroxide, calcium hydroxide, and mixtures thereof.

12. The system of 11, wherein the first mixing system comprises a vessel filled with water in which the duct which carries the gas emissions stream is submerged in the water for the mixing to take place.

13. The of claim 11, wherein the first mixing system further comprises a water injection system that injects water to the duct that carries the gas emissions stream, wherein the mixing is done in the duct by the gas stream turbulence.

14. The system of claim 1, wherein the system for eliminating emissions is applied to an internal combustion motor of an automobile vehicle.

15. The system of claim 14, wherein the system for eliminating emissions has a continuous gas flow since the vacuum formed in the automobile vehicle's internal combustion motor sucks the gases inside the system at the time that the gases generated by the automobile vehicle's internal combustion motor push the gases inside the system for eliminating emissions of gases.

16. The system of claim 1, wherein the system for eliminating emissions is applied to an industrial combustion process.

17. The system of claim 1, wherein the industrial combustion process is a process from the group that consists of electric energy generation and steam generation in boilers processes.

18. The system of claim 1, wherein the system for eliminating emissions is applied to stationary motors, motor generators, motor compressors, nautical transports, trains and terrestrial transports.

19. The system of claim 1, further including an air admission pump, wherein the air supplied by the pump helps to improve the mixing of polluting gases with water and inorganic material.
